(19) United States
(12) Patent Application Publication
(10) Pub. No.: US 2008/0055471 A1
(43) Pub. Date: Mar. 6, 2008

(54) VIDEO INTEGRATED CIRCUIT AND VIDEO PROCESSING APPARATUS THEREOF

(75) Inventor: Kai-Liang Tsui, Taipei Hsien (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: BEACON ADVANCED TECHNOLOGY CO., LTD., Taipei Hsien (TW)

(21) Appl. No.: 11/741,434

(22) Filed: Apr. 27, 2007

(30) Foreign Application Priority Data
Aug. 30, 2006 (TW) 095215381

(51) Int. Cl. H04N 5/45

(52) U.S. Cl. 348/565; 348/E05.112

(57) ABSTRACT

Both a video integrated circuit that is connected to a video display apparatus for processing and displaying a plurality of video signals, and the video display apparatus thereof, are provided. The video integrated circuit and the video processing apparatus comprise a processor, a video capture unit, a watermark generating unit, a codec, and a video output unit. The video capture unit receives a digital video signal in response to a first signal from the processor to generate a processing signal. The watermark generating unit receives the processing signal in response to a second signal from the processor, and then embeds a watermark into a video corresponding to the processing signal to generate an integrated signal. The codec receives and compresses the integrated signal in response to a third signal from the processor, and then generates a compressed signal. The video output unit outputs the compressed signal to the video display apparatus in response to a fourth signal from the processor.

This application claims priority to Taiwan Patent Application No. 095215381 filed on Aug. 30, 2006, the disclosure of which is incorporated by reference herein in its entirety.

### CROSS-REFERENCES TO RELATED APPLICATIONS

Not applicable.

### BACKGROUND OF THE INVENTION

1. Field of the Invention

The present invention relates to a video integrated circuit and a video processing apparatus thereof; more particularly, it relates to a video integrated circuit and a video processing apparatus thereof for processing a video signal.

2. Descriptions of the Related Art

Due to the rapid development of technology for processing images, video display apparatuses have become more commonly used. However, conventional video display apparatuses that merely display single images are unable receive a multitude of information in a short time. For this reason, video display apparatuses that offer picture-in-picture (PIP) displays or picture-on-picture (POP) displays have been created.

Conventional video display apparatuses that process a plurality of images require a plurality of integrated circuits. For instance, when processing a plurality of digital video signal inputs and generating the corresponding images, many types of integrated circuits, such as a processor, a video output/input port unit, a codec, an integrated drive electronics (IDE) controller, etc., are all required for operation. The combination of all the needed integrated circuits results in a large and costly apparatus, and thus, becomes less desirable in a time where light-weight, thin and small apparatuses are in demand.

Therefore, it is important to create a video integrated circuit that can process various video signals with only a single integrated circuit, as well as a video processing apparatus thereof.

### SUMMARY OF THE INVENTION

An objective of this invention is to provide a video integrated circuit connected to a video display apparatus. The video integrated circuit comprises a processor, a video capture unit, a watermark generation unit, a codec, and a video output unit. The video capture unit receives a digital video signal and generates a processing signal in response to a first signal from the processor. The watermark generation unit receives the processing signal and embeds a watermark into an image corresponding to the processing signal to generate an integrated signal in response to a second signal from the processor. The codec receives and compresses the integrated signal to generate a compressed signal in response to a third signal from the processor. The video output unit then outputs the compressed signal from the memory to the video display apparatus in response to a fourth signal from the processor. It should be noted that the aforementioned first, second, third, fourth signals that are sent to the video capture unit, the watermark generation unit, the codec, and the video output unit do not need to be the same signal.

Another objective of this invention is to provide a video processing apparatus connected to a video display apparatus. The video processing apparatus comprises a first video integrated circuit and a second integrated circuit. Both the first video integrated circuit and the second integrated circuit comprise a processor, a video capture unit, a watermark generation unit, a codec, and a video output unit. The video capture unit comprises a first input end and a second input end, and is configured to receive a digital video signal via the first input end and generate a processing signal in response to a first signal from the processor. The watermark generation unit receives the processing signal and embeds a watermark into an image corresponding to the processing signal to generate an integrated signal in response to a second signal from the processor. The codec receives and compresses the integrated signal to generate a compressed signal in response to a third signal from the processor. The video output unit comprises a first output end and a second output end, and is configured to output the compressed signal to the video display apparatus via the first output end in response to a fourth signal from the processor. The second output end of the video output unit of the first integrated circuit is connected to the second input end of the video capture unit of the second integrated circuit, where the compressed signal of the first video integrated circuit is transmitted to the second video integrated circuit. The signals that are sent to the aforementioned units do not need to be the same signal as well.

The present invention adapts a single integrated circuit for several types of video processing.

The present invention reduces circuit layout area, minimizes product dimensions, and simplifies the manufacturing processes.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a first embodiment of a video integrated circuit in accordance with the present invention;

FIG. 2 shows a first embodiment of a video integrated circuit in accordance with the present invention; and

FIG. 3 shows an embodiment of a video processing apparatus in accordance with the present invention.

### DESCRIPTION OF THE PREFERRED EMBODIMENT

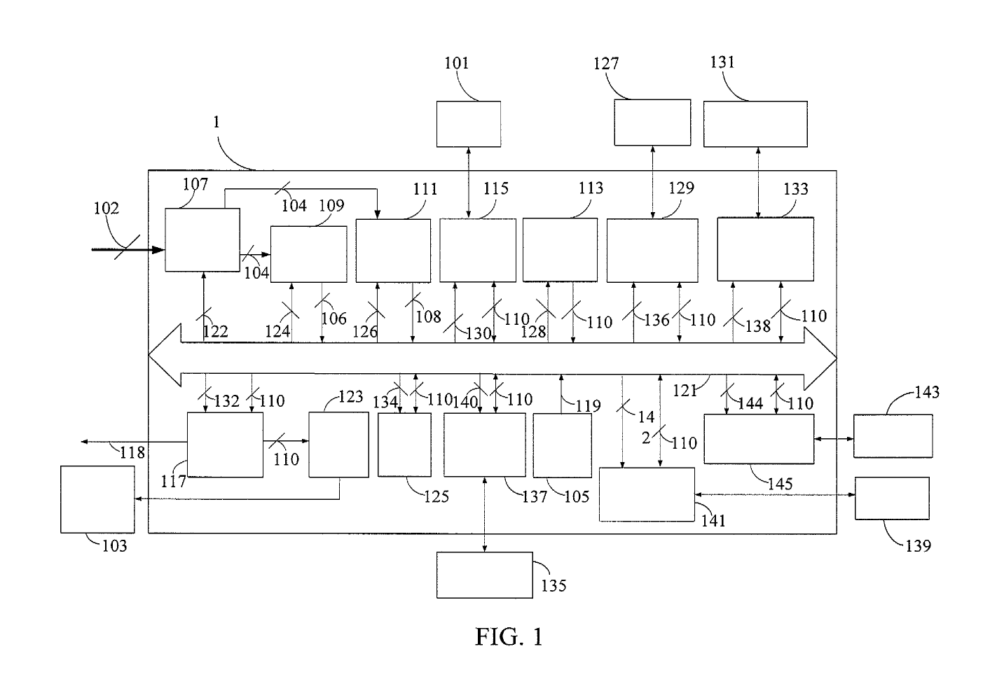

A first embodiment of the present invention is a video integrated circuit 1 for processing at least one digital video signal and for outputting the processed digital signal to a video display apparatus 103, as shown in FIG. 1.

The video integrated circuit 1 is electrically connected to a memory 101 and a video display apparatus 103. The video integrated circuit 1 comprises a processor 105, a video capture unit 107, a watermark generation unit 109, an image recognition unit 111, a codec 113, a memory control unit 115, and a video output unit 117. The processor 105 outputs signals via a line 119 and a bus 121 to control other units of the video integrated circuit 1. The video capture unit 107 receives a first signal 122 outputted from the processor 105 via the line 119 and the bus 121 and receives at least one digital video signal 102 in response to the first signal 122. The a processing signal 104 is generated. The processing signal 104 is then transmitted to the bus 121. In this embodiment, the bus 121 is an advanced high performance bus (AHB).

The watermark generation unit 109 receives a second signal 124 outputted from the processor 105 via the line 119 and the bus 121, receives the processing signal 104 from the video capture unit 107, and embeds a watermark into an image corresponding to the processing signal 104 to generate an integrated signal 106 in response to the second signal 124. The watermark can be regarded as noise data and is embedded into a specific position of the signal, which relates to the original data, to prevent impermissible processes, such as conversion between digital and analog, filtering, compression, and editing. Aside from the image recited in this embodiment, the watermark may further be embedded into data of a text format, a still image format, a video format, or an audio format. The watermark can be of two types: visible and invisible to the naked eye.

The image recognition unit 111 receives a third signal 126, comprising a comparison signal (not shown), outputted from the processor 105 via the line 119 and the bus 121, and retrieves the processing signal 104 with image information from the video capture unit 107 in response to the third signal 126. The image recognition unit 111 then samples from the image information, and compares the comparison signal for recognizing the image and generating a recognition result signal 108. The image recognition unit 111 transmits the recognition result signal 108 to the processor 105. The comparison signal in the third signal 126 can be determined by a user via program control. For example, the digital video signal 102 can correspond to a fingerprint if adapting to the fingerprint recognition field. The processor 105 would generate the third signal 126 according to reference fingerprint information stored in the memory 101, wherein the comparison signal in the third signal 126 comprises this reference fingerprint information. When the image recognition unit 111 receives the third signal 126, the image information is sampled in response to the processing signal 104. After sampling, a sampling result and the comparison signal are compared. If there is a certain degree of similarity between the sampling result and the comparison signal, the processing signal 104 with the image information is added a comparison result to generate the recognition result signal 108. The recognition result signal 108 is the image signal of the similar fingerprint.

After receiving a fourth signal 128 outputted from the processor 105 via the line 119 and the bus 121, the codec 113 receives the integrated signal 106 from the bus 121 and compresses the integrated signal 106 or the recognition result signal 108 to generate a compressed signal 110 in response to the fourth signal 128. The compression format can be in a joint photographic experts group (JPEG) format, an MPEG-4 format, or a H.264 standard format.

The memory control unit 111 receives a fifth signal 130 outputted from the processor 105 via the line 119 and the bus 121, and the compressed signal 110 generated by the codec 113 is stored in the memory 101 in response to the fifth signal 130. The memory 101 can be a static memory or a double data rate (DDR) memory. If the memory 101 is the static memory, the corresponding memory control unit 115 is a static memory control unit. If the memory 101 is the DDR memory, the corresponding memory control unit 115 is a DDR memory control unit.

When the compressed signal 110 needs to be captured, the processor 105 transmits a sixth signal 132 via the line 119 and the bus 121 to the video output unit 117. The video output unit 117 captures the compressed signal 110 from the memory 101 in response to the sixth signal 132, encodes and then outputs the compressed signal 110 to the video display apparatus 103 to show the image of the digital video signal 102 with an embedded watermark. The video output unit 117 may output the decompressed compressed signal 110 to a back end video integrated circuit via the line 118.

The video integrated circuit 1 further comprises a video encoder 123, disposed between the video output unit 117 and the video display apparatus 103. The video output unit 117 outputs the decompressed compressed signal 110 to the video display apparatus 103 through the video encoder 123. The video encoder 123 encodes the compressed signal 100 captured from the video output unit 117, and outputs the encoded compressed signal to the video output apparatus 103. The video encoder 123 can be a video graphics array (VGA) encoder or a TV encoder. If the video encoder 123 is the VGA encoder, the video integrated circuit 1 may directly generate a VGA signal using a corresponding VGA display apparatus, a projector, or an LCD apparatus. If the video encoder 123 is the TV encoder, the video integrated circuit 1 may generate a TV signal, with a corresponding TV or a projector.

The video integrated circuit 1 further comprises an encryption unit 125. After receiving a seventh signal 134 outputted from the processor 105 via the line 119 and the bus 121, the compressed signal 110 is encrypted with a key in response to the seventh signal. The encryption unit 125 can be a data encryption standard (DES) unit, a triple data encryption standard (3DES) unit, or any other encryption standard unit.

The video integrated circuit 1 is further connected to a hard disk 127. The video integrated circuit 1 further comprises an integrated drive electronics (IDE) controller 129. After receiving an eighth signal 136 outputted from the processor 105 via the line 119 and the bus 121, the compressed signal 110 is stored in the hard disk 127. Since the hard disk 127 can store a great deal of data, the compressed signal 110 can be preserved for a long time. The compressed signal 140 may be read from the hard disk 127 for displaying or for further processing when it is needed.

The video integrated circuit 1 is further connected to a peripheral controller interface (PCI) bus 131. The video integrated circuit 1 further comprises a PCI unit 133. The PCI unit 133 receives a ninth signal 138 outputted from the processor 105 via the line 119 and the bus 121, and then outputs the compressed signal 110 to the PCI bus 131 in response to the ninth signal 138. The PCI bus 131 is a standard interface for data transmission of a computer. The compressed signal 110 may be transmitted for display on the computer or for being further processed via the PCI bus 131.

The video integrated circuit 1 is further connected to a serial advanced technology attachment (SATA) interface 135. The video integrated circuit 1 further comprises a SATA controller 137 for outputting the compressed signal 110 to the SATA interface 135 in response to a tenth signal 140 after receiving the tenth signal 140 from the processor 105 via the line 119 and the bus 121. The SATA interface 135 is also an interface connected to a host or a multimedia apparatus. The compressed signal 104 may be transmitted for display on the computer or for being further processed via the SATA interface 135.

In addition, the video integrated circuit 1 is also connected to a universal serial bus (USB) port 139. The video integrated circuit 1 further comprises a USB unit 141 for outputting the compressed signal 110 to the USB port 139 in response to the eleventh signal 142 after receiving the eleventh signal 142 from the processor 105 via the line 119 and the bus 121. The USB port 139 is also an interface connected to a host, where the compressed signal 110 may be transmitted for display on the computer or for being further processed via the USB port 139.

The video integrated circuit 1 is also connected to an Ethernet physical layer 143. The video integrated circuit 1 further comprises an Ethernet medium access control layer 145 for outputting the compressed signal 110 to the Ethernet physical layer 143 in response to a twelfth signal 144 after receiving the twelfth signal 144 from the processor 105 via the line 119 and the bus 121. The compressed signal 110 may be transmitted to the Internet via the Ethernet physical layer 143.

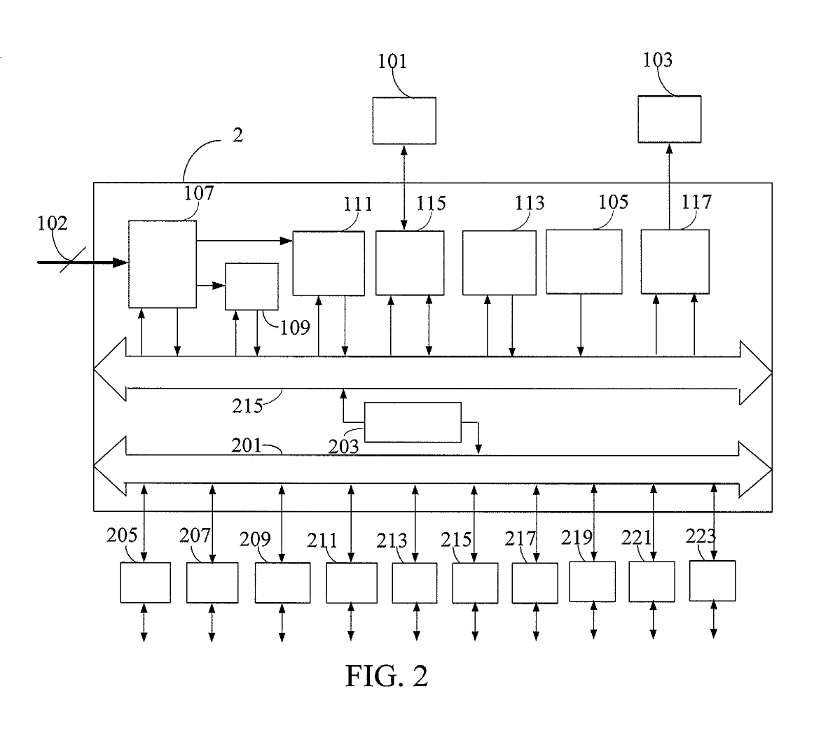

A second embodiment of the present invention is shown in FIG. 2. A video integrated circuit 2 is also electrically connected to a memory 101 and a video display apparatus 103. The video integrated circuit 2 also comprises a processor 105, a video capture unit 107, a watermark generation unit 109, an image recognition unit 111, a codec 113, a memory control unit 115, and a video output unit 117. The functions of the aforementioned units are the same as the functions of the corresponding units in the first embodiment, and thus, are not depicted here. Moreover, the first bus 215 of the video integrated circuit 2 is the same as the bus 121 in the first embodiment, and is not repeated here as well.

The video integrated circuit 2 differs from the video integrated circuit 1 in further comprising a second bus 201 and a bus bridge 203, wherein the second bus 201 is an advanced peripheral bus (APB), and the bus bridge 203 is an AHB-APB bridge for connecting the first bus 215 and the second bus 201. The second bus 201 is further connected to an I²C bus 205, a serial peripheral interface (SPI) 207, an IrDA interface 209, a storage card interface 211, a GPIO port 213, an audio interface 215, which can be an inter IC sound (I²S) interface, a stereo audio codec interface 217, a keyboard/mouse interface 219, a UART interface 221, and an interrupt controller 223. The second bus 201 transmits the signals to the first bus 215 via the bus bridge 203. Therefore, any signal generated by the processor 105, the video capture unit 107, the watermark generation unit 109, the image recognition unit 111, the codec 113, the memory control unit 115, or the video output unit 117 may be transmitted via the aforementioned interfaces 205, 207, 209, 211, 213, 215, 217, 219, 221, and 223. Furthermore, the user may input a control signal or a datum to the video integrated circuit 2 via the aforementioned interfaces 205, 207, 209, 211, 213, 215, 217, 219, 221, and 223.

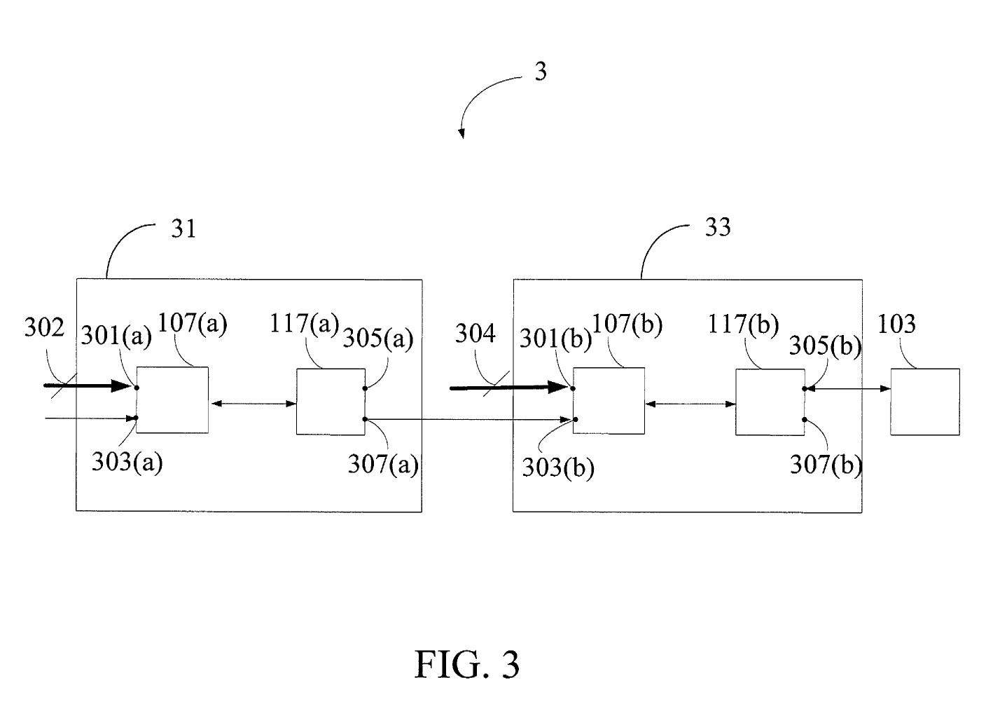

The present invention further provides a video processing apparatus; the embodiment thereof is illustrated in FIG. 3. The video processing apparatus 3 processes and controls a plurality of digital video signals and then displays the processed and controlled plurality of digital video signals to the displays, such as an LCD, a TV, a monitor, a projector, etc. The video processing apparatus 3 enables a signal display to display a plurality of images at the same time.

The video processing apparatus 3 comprises a first video integrated circuit 31 and a second video integrated circuit 33. The units in the first video integrated circuit 31 and the second video integrated circuit 33 are identical to the video integrated circuits of the first embodiment and the second embodiment. The video capture unit 107(a) of the first video integrated circuit 31 further comprises a first input end 301(a) and a second input end 303(a). The video capture unit 107(b) of the second video integrated circuit 33 further comprises a first input end 301(b) and a second input end 303(b). The first input end 301(a) and the first input end 301(b) are configured to receive at least one digital video signal 302, 304 to generate the aforementioned compressed signal. The second input end 303(b) is connected to a video output unit 117(a) of a front end video integrated circuit 31. The video output unit 117(a) of the first video integrated circuit 31 further comprises a first output end 305(a) and a second output end 307(a). The video output unit 117(b) of the second video integrated circuit 33 further comprises a first output end 305(b) and a second output end 307(b). The first output end 305(b) outputs the compressed signal to a video display apparatus 103. The second output end 307(a) is connected to the second input end 303(b) of the video capture unit 107(b) of a back end video integrated circuit. In this embodiment, the second output end 303(b) of the video output unit 117(a) of the first video integrated circuit 31 is connected to the second input end 303(b) of the video capture unit 107(b) of the second video integrated circuit 33. The compressed signal of the first video integrated circuit 31 can then be inputted into the second video integrated circuit 33.

If both the video integrated circuit 1 and the video integrated circuit 2 can process four video signals each, then a total of eight images can be outputted, wherein four out of the eight images are generated from the digital video signal of the first input end 301(a) of the video capture unit 107(a) of the first video integrated circuit 31, while the other four images are generated from the digital video signal of the first input end 301(b) of the video capture unit 107(b) of the first video integrated circuit 33. The second video integrated circuit 33 enables the eight images to be displayed simultaneously on the video display apparatus 103 via the first output end 305(b).

Though the embodiment illustrates a video processing apparatus comprising two video integrated circuits, people skilled in this field may proceed with a variety of modifications with the video processing apparatus using more than two video integrated circuits. For example, a video processing apparatus that comprises four video integrated circuits may display sixteen images at the same time.

The video integrated circuit 1, the video integrated circuit 2, and the video processing apparatus 3 receive at least one digital video signal, where at least one image will be processed and displayed. The prior art required many apparatuses for processing a plurality of video signals, resulting in high costs and large size. The video integrated circuit of the present invention integrates the functions of many conventional integrated circuit chips on a single integrated circuit chip. The integration of the present invention decreases the area for the layout, and further saves costs and minimizes the product dimensions.

The above disclosure is related to the detailed technical contents and inventive features of the subject invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A video integrated circuit connected to a video display apparatus, comprising:
a processor;
a video capture unit for receiving a digital video signal and generating a processing signal in response to a first signal from the processor;
a watermark generation unit for receiving the processing signal and for embedding a watermark into an image corresponding to the processing signal to generate an integrated signal in response to a second signal from the processor;
a codec for receiving and compressing the integrated signal to generate a compressed signal in response to a third signal from the processor; and
a video output unit for outputting the compressed signal to the video display apparatus in response to a fourth signal from the processor.

2. The video integrated circuit as claimed in claim 1, further comprising an image recognition unit for recognizing the image and generating a recognition result in response to a fifth signal from the processor and for transmitting the recognition result to the processor.

3. The video integrated circuit as claimed in claim 1, further comprising a video encoder between the video output unit and the video display apparatus for encoding the compressed signal from the video output unit and for outputting the encoded compressed signal to the video display apparatus.

4. The video integrated circuit as claimed in claim 3, wherein the video encoder is a video graphics array (VGA) encoder, and the video display apparatus is one of a VGA display apparatus and a liquid crystal display apparatus.

5. The video integrated circuit as claimed in claim 3, wherein the video encoder is a VGA encoder, and the video display apparatus is a TV.

6. The video integrated circuit as claimed in claim 1, further connected to a memory, wherein the video integrated circuit further comprises a memory controller for storing the compressed signal in the memory in response to a sixth signal from the processor.

7. The video integrated circuit as claimed in claim 6, wherein the memory is a static memory, and the memory controller is a static memory controller.

8. The video integrated circuit as claimed in claim 6, wherein the memory is a double data rate (DDR) memory, and the memory controller is a DDR memory controller.

9. The video integrated circuit as claimed in claim 1, further connected to a hard disk, wherein the video integrated circuit further comprises an integrated drive electronics (IDE) controller for storing the compressed signal in the hard disk in response to a seventh signal from the processor.

10. The video integrated circuit as claimed in claim 1, further connected to a peripheral controller interface (PCI) bus, wherein the video integrated circuit further comprises a PCI unit for outputting the compressed signal to the PCI bus in response to an eighth signal from the processor.

11. The video integrated circuit as claimed in claim 1, further connected to a serial advanced technology attachment (SATA) interface, wherein the video integrated circuit further comprises a SATA controller for outputting the compressed signal to the USB port in response to a ninth signal from the processor.

12. The video integrated circuit as claimed in claim 1, further connected to a universal serial bus (USB) port, wherein the video integrated circuit further comprises a USB unit for outputting the compressed signal to the USB port in response to a tenth signal from the processor.

13. The video integrated circuit as claimed in claim 1, further connected to an Ethernet physical layer, wherein the video integrated circuit further comprises an Ethernet medium access control layer for outputting the compressed signal to the Ethernet physical layer in response to an eleventh signal from the processor.

14. The video integrated circuit as claimed in claim 1, further comprises an encryption unit for encrypting the compressed signal in response to a twelfth signal from the processor.

15. The video integrated circuit as claimed in claim 14, wherein the encryption unit is one of a data encryption standard (DES) unit and a triple data encryption standard (3DES) unit.

16. The video integrated circuit as claimed in claim 1, wherein the codec performs the compression in one of an H.264 format, an MPEG-4 format, and a JPEG format.

17. The video integrated circuit as claimed in claim 1, further comprising an advanced high performance bus (AHB) for transmitting the signals of the processor and the processing signal.

18. A video processing apparatus connected to a video display apparatus, the video processing apparatus comprising a first video integrated circuit and a second integrated circuit, each of the first video integrated circuit and the second integrated circuit comprising:
a processor;
a video capture unit, comprising a first input end and a second input end, for receiving a digital video signal via the first input end and generating a processing signal in response to a first signal from the processor;
a watermark generation unit for receiving the processing signal and embedding a watermark into an image corresponding to the processing signal to generate an integrated signal in response to a second signal from the processor;
a codec for receiving and compressing the integrated signal to generate a compressed signal in response to a third signal from the processor; and
a video output unit, comprising a first output end and a second output end, for outputting the compressed signal to the video display apparatus via the first output end in response to a fourth signal from the processor;
wherein the second output end of the video output unit of the first integrated circuit is connected to the second input end of the video capture unit of the second integrated circuit, and the compressed signal of the first video integrated circuit is transmitted to the second video integrated circuit.

19. The video processing apparatus as claimed in claim 18, wherein the first video integrated circuit is the video integrated circuit claimed in claim 1.

20. The video processing apparatus as claimed in claim 18, wherein the second video integrated circuit is the video integrated circuit claimed in claim 1.
